(19) United States
(12) Patent Application Publication
(10) Pub. No.: US 2026/0025253 A1
(43) Pub. Date: Jan. 22, 2026

(54) REPORTING NON-ZERO COEFFICIENT BITMAP FOR COHERENT JOINT TRANSMISSION WITH CODEBOOK

(71) Applicant: Telefonaktiebolaget LM Ericsson (publ), Stockholm (SE)

(72) Inventors: Xinlin ZHANG, VÄSTRA FRÖLUNDA (SE); Siva MURUGANATHAN, STITTSVILLE (CA); Shiwei GAO, NEPEAN (CA); Fredrik ATHLEY, VÄSTRA FRÖLUNDA (SE)

(73) Assignee: Telefonaktiebolaget LM Ericsson (publ), Stockholm (SE)

(21) Appl. No.: 19/116,505

(22) PCT Filed: Sep. 29, 2023
(86) PCT No.: PCT/IB2023/059815

§ 371 Date: Mar. 28, 2025

Related U.S. Application Data
(60) Provisional application No. 63/412,067, filed on Sep. 30, 2022.
(60) Provisional application No. 63/415,880, filed on Oct. 13, 2022.

(51) Int. Cl. H04L 5/00; H04B 7/06; H04W 24/08

(52) U.S. Cl. CPC H04L 5/0057; H04B 7/0626; H04W 24/08

(57) ABSTRACT

A method performed by a user equipment (UE) according to some embodiments includes receiving (502) an indication from a network node for a plurality of non-zero power (NZP) channel state information reference signal (CSI-RS) resources for channel measurement, and performing (504) channel measurement on the plurality of NZP CSI-RS resources. The UE selects (505) one or more NZP CSI-RS resources from the plurality of NZP CSI-RS resources, and generates (506) a CSI report based on the channel measurement and the selected one or more NZP CSI-RS resources. The CSI report includes indicators for the one or more selected NZP CSI-RS resources, and non-zero coefficient bitmaps corresponding to the one or more selected NZP CSI-RS resources. The UE transmits (508) the CSI report to the network.

### RELATED APPLICATIONS

This application claims priority to U.S. Provisional Application No. 63/412,067 filed on Sep. 30, 2022 and U.S. Provisional Application No. 63/415,880 filed on Oct. 13, 2022.

### TECHNICAL FIELD

The present disclosure relates to wireless communication networks, and in particular to wireless communication networks that employ codebook-based precoding for spatial multiplexing.

### BACKGROUND

### Codebook-Based Precoding

Multi-antenna techniques can significantly increase the data rates and reliability of a wireless communication system. The performance may be improved if both the transmitter and the receiver are equipped with multiple antennas, which results in a multiple-input multiple-output (MIMO) communication channel. Such systems and/or related techniques are commonly referred to as MIMO.

A core component of the fifth Generation (5G) wireless network such as New Radio (NR) is the support of MIMO antenna deployments and MIMO related techniques such as spatial multiplexing. Spatial multiplexing can be used to increase data rates in favorable channel conditions.

FIG. 1 shows an example of spatial multiplexing. An information carrying symbol vector s is multiplied by an N_{T}×r precoding matrix or precoder W, which serves to distribute the transmit energy in a subspace of the N_{T} dimensional vector space. The precoding matrix is typically selected from a codebook of possible precoding matrices, and typically indicated by means of a precoding matrix indicator (PMI), which specifies a unique precoding matrix in the codebook for a given number of symbol streams. The r symbols in s each correspond to a MIMO layer and r is referred to as the transmission rank, which equals to the number of columns of the precoder W. In this way, spatial multiplexing is achieved since multiple symbols can be transmitted simultaneously over the same time/frequency resource element (RE). The number of symbols r is typically adapted to suit the current channel properties.

NR uses Orthogonal Division Multiplexing (OFDM) in downlink. The received N_{R}×1 vector yₙ at a user equipment (UE) on a certain RE can be expressed as:

$${y}_{n} = {H}_{n} {Ws}_{n} + {e}_{n}$$

where eₙ is a receiver noise/interference vector. The precoder W can be constant over frequency (i.e., wideband), or frequency selective (i.e., per subband).

The precoder W is chosen to match the characteristics of the N_{R}×N_{T} MIMO channel matrix Hₙ, resulting in so-called channel dependent precoding. This is also commonly referred to as closed-loop precoding.

In closed-loop precoding, the UE feeds back recommendations on a suitable precoder to the gNodeB (gNB) in the form of a PMI based on downlink channel measurements. For that purpose, the UE is configured with a channel state information (CSI) report configuration including CSI reference signals (CSI-RS) for channel measurements and a codebook of candidate precoders. In addition to precoders, the feedback may also include a rank indicator (RI) and one or two channel quality indicators (CQIs). RI, PMI and CQI are part of a CSI feedback. In NR, CSI feedback can be either wideband, where one CSI is reported for the entire channel bandwidth, or frequency-selective, where one CSI is reported for each subband, which is defined as a number of contiguous physical resource blocks (PRBs) ranging between 4-32 PRBs depending on the band width part (BWP) size.

Given the CSI feedback from the UE, the gNB determines the transmission parameters it wishes to use to transmit to the UE, including the precoding matrix, transmission rank, and modulation and coding scheme (MCS).

2D Antenna arrays

Two-dimensional antenna arrays can be described by a number of antenna ports, N₁, in a first dimension (e.g., the horizontal dimension), a number of antenna ports, N₂, in the second dimension, perpendicular to the first dimension (e.g., the vertical dimension), and a number of polarizations Nₚ. The total number of antenna ports is thus N=N₁N₂Nₚ. The concept of an antenna port is non-limiting in the sense that it can refer to any virtualization (e.g., linear mapping) to the physical antenna elements. For example, pairs of physical antenna elements could be fed the same signal, and hence share the same virtualized antenna port.

An example of a 4×4 (i.e., N₁×N₂,) array with dual-polarized antenna elements (i.e., Nₚ=2) is illustrated in FIG. 2.

FIG. 2 is an exemplary illustration of a two-dimensional antenna array of dual-polarized antenna elements (Nₚ=2), with N₁=4 horizontal antenna elements and N₂=4 vertical antenna elements.

Precoding may be interpreted as multiplying the signal to be transmitted a set of beamforming weights on the antenna ports prior to transmission. A typical approach is to tailor the precoder to the antenna form factor, i.e. taking into account N₁, N₂ and Nₚ when designing the precoder codebook.

### Channel State Information Reference Signals (CSI-RS)

For CSI measurement and feedback, CSI-RS are defined. A CSI-RS is transmitted on each antenna port and is used by a UE to measure downlink channel between each of the transmit antenna ports and each of its receive antenna ports. The transmit antenna ports are also referred to as CSI-RS ports. The supported number of antenna ports in NR are {1, 2, 4, 8, 12, 16, 24, 32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain REs in a slot and certain slots. FIG. 3 shows an example of CSI-RS REs for 12 antenna ports, where 1 RE per RB per port is shown. FIG. 3 shows an example of RE allocation for a 12-port CSI-RS in NR.

In addition, interference measurement resource (IMR) is also defined in NR for a UE to measure interference. An IMR resource contains 4 REs, either 4 adjacent RE in frequency in the same OFDM symbol or 2 by 2 adjacent REs in both time and frequency in a slot. By measuring both the channel based on NZP CSI-RS and the interference based on an IMR, a UE can estimate the effective channel and noise plus interference to determine the CSI, i.e., rank, precoding matrix, and the channel quality. Furthermore, a UE in NR may be configured to measure interference based on one or multiple NZP CSI-RS resource.

### CSI Framework in NR

In NR, a UE can be configured with multiple CSI reporting settings and multiple CSI-RS resource settings. Each resource setting can contain multiple resource sets, and each resource set can contain up to eight CSI-RS resources. For each CSI reporting setting, a UE feeds back a CSI report.

Each CSI reporting setting contains at least the following information:
A CSI-RS resource set for channel measurement
Optionally, a CSI-RS resource set for interference measurement
Time-domain behavior, i.e., periodic, semi-persistent, or aperiodic reporting
Frequency granularity, i.e., wideband or subband
CSI parameters to be reported such as RI, PMI, CQI, and CSI-RS resource indicator (CRI) in case of multiple CSI-RS resources in a resource set
Codebook types, i.e., type I or II, and codebook subset restriction
Measurement restriction
Subband size. One out of two possible subband sizes is indicated, the value range depends on the bandwidth of the BWP. One CQI/PMI (if configured for subband reporting) is fed back per subband).
   NR Rel-16 Enhanced Type II (eTypeII) Codebook

The NR Rel-15 type II codebook is enhanced in NR Rel-16 in which instead of reporting separate precoders for different subbands, the precoders for all subbands are reported together by using a so-called frequency domain (FD) basis. It takes advantage of frequency domain channel correlations by representing the precoder changes in frequency domain with a set of frequency domain DFT basis vectors (which will be simply referred to as frequency domain basis vectors). Due to channel correlation in frequency, only a few DFT basis vectors may be used to represent the precoder changes over all the subbands. By doing so, the feedback overhead can be reduced, or performance can be improved, for the same feedback overhead.

For a given CSI-RS resource with N₁ CSI-RS antenna ports in one dimension and N₂ CSI-RS antenna ports in another dimension, and with two polarizations, the Rel-16 type II codebook-based precoding vectors for each layer l (l=1, . . . , v) and across all subbands can be expressed as:

$${W}_{l} = [ \begin{matrix}{w}_{l}^{( 0 )} & … & {w}_{l}^{( {N}_{3} - 1 )}\end{matrix} ] = {W}_{1} {\tilde{W}}_{2 , l} {W}_{f , l}^{H} ,$$

where:

$${w}_{l}^{( t )}$$

is a P_{CSI-RS}×1 precoding vector at a PMI subband with subband index t∈{0, 1, . . . , N₃−1} for layer l, where P_{CSI-RS}=2N₁N₂is the number of CSI-RS ports in a configured NZP CSI-RS resource;
N₃=N_{SB}×R is the number of subbands for PMI, where N_{SB} is the number of CQI subbands and R∈{1, 2} is a scaling factor, both N_{SB} and R are RRC configured;
W₁ is the same as in Rel-15 type II codebook and contains a set of selected beams or SD basis vector; and

$${w}_{f , l} = [ {y}_{l}^{( 0 )} , {y}_{l}^{( 1 )} , … , {y}_{l}^{( {M}_{v} - 1 )} ]$$

is a size N₃×Mᵥ frequency domain (FD) compression matrix for layer l comprising Mᵥ selected FD basis vectors and

$${y}_{l}^{( f )} = {[ {y}_{0 , l}^{( f )} , {y}_{1 , l}^{( f )} , … , {y}_{{N}_{3} - 1 , l}^{( f )} ]}^{T} and {y}_{t , l}^{( f )} = {e}^{- j 2 π {tn}_{3 , l}^{( f )} / {N}_{3}} , t = 0 , 1 , … , {N}_{3} - 1 , {n}_{3 , l}^{( f )} ∈ \{ 0 , 1 , … , {N}_{3} - 1 \} . {M}_{v} = ⌈ {p}_{v} \frac{{N}_{3}}{R} ⌉$$

is the number of selected FD basis vectors, which depends on the rank v and the RRC configured parameter pᵥ. Supported values of pᵥ can be found in Table 5.2.2.2.5-1 of 3GPP TS 38.214 v16.14.0.
\tilde{W}_{2,l}=[\tilde{w}_{l,i,f}, i=0, 1, . . . , 2 L−1, f=0, 1, . . . , Mᵥ−1] is a size 2 L×Mᵥ coefficient matrix. For layer l, only a subset of

$${K}_{l}^{NZ} \leq {K}_{0}$$

coefficients are non-Zero and reported by the UE. The remaining

$$2 {LM}_{v} - {K}_{l}^{NZ}$$

non-reported coefficients are considered zero.
K₀=[β×2 LM₁] is the maximum number of non-zero coefficients per layer, where β is a RRC configured parameter. Supported β values are shown in the table shown in Table 5.2.2.2.5-1 of 3GPP TS 38.214 v16.14.0.
For v∈{2, 3, 4}, the total number of non-zero coefficients summed across all layers,

$${K}_{tot}^{NZ} = {\sum }_{l = 1}^{v} {K}_{l}^{NZ} ,$$

shall satisfy

$${K}_{tot}^{NZ} \leq 2 {K}_{0} .$$

Selected coefficient subset for each layer is indicated with

$${K}_{l}^{NZ}$$

1 s in a size 2 LMᵥ bitmap, i_{1,7,l}.
The strongest coefficient of layer l (whose amplitude and phase are not reported) is identified by i_{1,8,l}, ∈{0, 1, . . . , 2 L−1}.
The amplitude coefficients in W_{2,l} are indicated by i_{2,3,l} and i_{2,4,l}, and the phase coefficients in W_{2,l} are indicated by i_{2,5,l}.

The above is described in section 5.2.2.2.5 of 3GPP TS 38.214 v16.14.0.

The enhanced Type II (eType II) port selection (PS) codebook was also introduced in Rel-16, which is intended to be used for beamformed CSI-RS, i.e., each CSI-RS port corresponds to a 2D spatial beam. Based on the measurement, the UE selects the best CSI-RS ports and recommends a rank, a precoding matrix, and a CQI conditioned on the rank and the precoding matrix to the gNB.

The precoding matrix comprises linear combinations of the selected CSI-RS ports. For a given transmission layer l, with l∈{1, . . . , v} and v being the rank indicated by the rank indicator (RI), the precoder matrix has the same form as the Rel16 enhanced Type II codebook, i.e.:

$${W}_{l} = [ \begin{matrix}{w}_{l}^{( 0 )} & … & {w}_{l}^{( {N}_{3} - 1 )}\end{matrix} ] = {W}_{1} {\tilde{W}}_{2 , l} {W}_{f , l}^{H} ,$$

The matrices \tilde{W}_{2,l} and W_{f,l} are the same as in the Rel-16 enhanced Type II codebook. The main difference is on W₁, which is a size P_{CSI-RS}×2 L port selection matrix given by

$${W}_{1} = [ \begin{matrix}{e}_{{m}^{( 0 )}} , … , {e}_{{m}^{( L - 1 )}} & 0 \\ 0 & {e}_{{m}^{( 0 )}} , … , {e}_{{m}^{( L - 1 )}}\end{matrix} ] ,$$

where eₘ_{⁽ⁱ⁾}=[0, . . . , 0, 1, 0, . . . , 0]^{T}, i=0, 1, . . . , L−1 is a port selection vector of size

$$\frac{{P}_{CSI - RS}}{2} \times 1$$

and contains one element with value of one at location

$${m}^{( i )} ∈ \{ 0 , 1 , … , ⌈ \frac{{P}_{CSI - RS}}{2 d} ⌉ - 1 \}$$

indicating the selected CSI-RS port while all the other elements are with values of zeros, e.g., e₀=[1, 0, . . . , 0]^{T} and e_{P}_{_{CSI-RS/2}}=[0, 0, . . . , 0, 1]^{T}. L is the number of selected CSI-RS ports from each polarization and the same ports are selected for both polarizations. Supported L values can be found in Table 5.2.2.2.6-1 of 3GPP TS 38.214 v16.14.0.

The value of d is configured with the higher layer parameter portSelectionSamplingSize, where d∈{1, 2, 3, 4} and

$$d < min ( \frac{{P}_{CSI - RS}}{2} , L ) .$$

Selected CSI-RS ports are indicated by i^{1,1}∈{0, 1, . . . , [P_{CSI-RS}/2d]−1}, which is reported by the UE to gNB. i_{1,2} is irrelevant and thus is not reported.

For Rel-16 Enhanced Type II CSI feedback, a CSI report includes two parts: Part 1 and Part 2. Part 1 has a fixed payload size and is used to identify the number of information bits in Part 2. Part 1 contains RI, CQI, and an indication of the overall number of non-zero amplitude coefficients across layers, i.e.,

$${K}_{t o t}^{N Z} ∈ \{ 1 , 2 , … , 2 {K}_{0} \} .$$

Part 2 contains the PMI. Part 1 and Part 2 of the CSI report are separately encoded.

### NR Rel-17 Further Enhanced Type II Port Selection Codebook

The Rel-16 port selection codebook is further enhanced in Rel-17, in which it is assumed that each CSI-RS port is associated to a channel delay and different channel delays are associated to different CSI-RS ports. It is also assumed that the delays associated to the CSI-RS ports have been pre-compensated before being transmitted and thus, only one or two frequency domain basis vectors may be selected by a UE, i.e., Mᵥ∈{1, 2}. The one or two FD basis vectors are the same for all layers, therefore M is used instead of Mᵥ.

The number, L, of CSI-RS ports or beams at each polarization to be selected is indirectly configured as L=αP_{CSI-RS}/2, where parameter α is configured by RRC as shown in Table 5.2.2.2.7-1 of 3GPP TS 38.214 v17.6.0.

The 2 L total CSI-RS ports are selected from P_{CSI-RS} ports based on L port selection vectors, eₘ_{⁽ⁱ⁾}, i=0, 1, . . . , L−1, which are identified by:

$$m = [ {m}^{( 0 )} … {m}^{( L - 1 )} ]$$

$${m}^{( i )} ∈ \{ 0 , 1 , … , \frac{{P}_{CSI - RS}}{2} - 1 \}$$

which are indicated by the index i_{1,2,} where:

$${i}_{1 , 2} ∈ \{ 0 , 1 , … , ( \begin{matrix}{P}_{CSI - RS} / 2 \\ L\end{matrix} ) - 1 \} .$$

The M selected FD basis vectors,

$${[ {y}_{0}^{( f )} , {y}_{1}^{( f )} , … , {y}_{{N}_{3} - 1}^{( f )} ]}^{T} ,$$

f∈{0, . . . , M−1}, are identified by n₃, and where:

$${n}_{3} = [ {n}_{3}^{( 0 )} … {n}_{3}^{( M - 1 )} ]$$

$${n}_{3}^{( f )} ∈ \{ \begin{matrix}\{ 0 \} & M = 1 \\ \{ 0 , 1 , … , min ( N , {N}_{3} ) - 1 \} & M = 2\end{matrix}$$

with the indices f∈{0, . . . , M−1} assigned such that

$${n}_{3}^{( f )}$$

increases with f. n₃ is indicated by the index i_{1,6}.

### Coherent Joint PDSCH Transmission From Multiple TRPs

In NR Rel-18, it has been agreed to support coherent joint downlink transmission (CJT) from multiple transmission and reception points (TRPs) by extending Rel-16 and Rel-17 enhanced type II codebook across multiple TRPs. In case of CJT, each layer of a PDSCH is transmitted from multiple TRPs. An example is shown in FIG. 4 which illustrates an example of CJT over two TRPs, a physical downlink shared channel (PDSCH) with two layers are transmitted from two TRPs by applying two different precoding matrices to the PDSCH at TRP1 and TRP2. The two precoders are designed such that for each layer, the signals received from the two TRPs are phase aligned at the UE and thus, are coherently combined at the UE.

Extension of NR Rel-16 type II codebook to CJT has been discussed in 3GPP and two modes of codebook structures for supporting CJT have been agreed as follows:
Mode 1: Per-TRP/TRP-group SD/FD basis selection which allows independent FD basis selection across N TRPs/TRP groups. Example formulation (N=number of TRPs or TRP groups):

$$[ \begin{matrix}{W}_{1 , 1} {\tilde{W}}_{2 , 1} {W}_{f , 1}^{\text{?}} \\ \text{?} \\ {W}_{1 , N} {\tilde{W}}_{2 , N} {W}_{f , N}^{\text{?}}\end{matrix} ]$$

$$\text{?} \text{indicates text missing or illegible when filed}$$

Mode 2: Per-TRP/TRP group (port-group or resource) SD basis selection and joint/common (across N TRPs) FD basis selection. Example formulation (N=number of TRPs or TRP groups):

$$[ \begin{matrix}{W}_{1 , 1} {\tilde{W}}_{2 , \text{?}} {W}_{f}^{\text{?}} \\ \text{?} \\ {W}_{1 , N} {{W}^{\text{?}}}_{2 ,} {W}_{f}^{\text{?}}\end{matrix} ]$$

$$\text{?} \text{indicates text missing or illegible when filed}$$

where W_{1,n} contains the selected beams or SD basis vectors for the nth TRP, W_{f,n} is the selected FD basis vectors associated to the nth TRP, \tilde{W}_{2,n} contains the coefficients associated with the nth TRP, W_{f} is a common set of selected FD basis vectors across all TRPs.

### SUMMARY

A method performed by a user equipment (UE) according to some embodiments includes receiving an indication from a network node for a plurality of non-zero power (NZP) channel state information reference signal (CSI-RS) resources for channel measurement, and performing channel measurement on the plurality of NZP CSI-RS resources. The UE selects one or more NZP CSI-RS resources from the plurality of NZP CSI-RS resources, and generates a CSI report based on the channel measurement and the selected one or more NZP CSI-RS resources. The CSI report includes an indicator for the one or more selected NZP CSI-RS resources, and non-zero coefficient bitmaps corresponding to the one or more selected NZP CSI-RS resources. The UE transmits the CSI report to the network.

A user equipment according to some embodiments includes a processing circuit, a communication interface coupled to the processing circuit, and a memory coupled to the processing circuit. The memory includes computer readable instructions that, when executed by the processing circuit, cause the user equipment to perform operations including receiving an indication from a network node for a plurality of non-zero power (NZP) channel state information reference signal (CSI-RS) resources for channel measurement, performing channel measurement on the plurality of NZP CSI-RS resources, selecting one or more NZP CSI-RS resources from the plurality of NZP CSI-RS resources, generating a CSI report based on the channel measurement and the selected one or more NZP CSI-RS resources where the CSI report includes an indicator for the one or more selected NZP CSI-RS resources and non-zero coefficient bitmaps corresponding to the one or more selected NZP CSI-RS resources, and transmitting the CSI report to the network.

Some embodiments provide a non-transitory medium including computer readable program instructions that, when executed by a processing circuit of a user equipment, cause the user equipment to perform operations including receiving an indication from a network node for a plurality of non-zero power (NZP) channel state information reference signal (CSI-RS) resources for channel measurement, performing channel measurement on the plurality of NZP CSI-RS resources, selecting one or more NZP CSI-RS resources from the plurality of NZP CSI-RS resources, generating a CSI report based on the channel measurement and the selected one or more NZP CSI-RS resources where the CSI report includes an indicator for the one or more selected NZP CSI-RS resources and non-zero coefficient bitmaps corresponding to the one or more selected NZP CSI-RS resources, and transmitting the CSI report to the network.

A method performed by a network node according to some embodiments includes transmitting an indication to a UE for a plurality of NZP CSI-RS resources for channel measurement, and receiving a CSI report based on a channel measurement on the plurality of NZP CSI-RS resources. The CSI report includes an indicator for one or more NZP CSI-RS resources selected by the UE, and non-zero coefficient bitmaps corresponding to the one or more selected NZP CSI-RS resources.

A network node according to some embodiments includes a processing circuit, a communication interface coupled to the processing circuit, and a memory coupled to the processing circuit. The memory includes computer readable instructions that, when executed by the processing circuit, cause the network node to perform operations including transmitting an indication to a UE for a plurality of NZP CSI-RS resources for channel measurement, and receiving a CSI report based on a channel measurement on the plurality of NZP CSI-RS resources. The CSI report includes an indicator for one or more NZP CSI-RS resources selected by the UE, and non-zero coefficient bitmaps corresponding to the one or more selected NZP CSI-RS resources.

Some embodiments provide a non-transitory medium including computer readable program instructions that, when executed by a processing circuit of a network node, cause the network node to perform operations of the method above, related to the network node.

### BRIEF DESCRIPTION OF THE DRAWINGS

FIG. 1 illustrates an exemplary transmission structure of spatial multiplexing in NR.

FIG. 2 is an exemplary illustration of a two-dimensional antenna array of dual-polarized antenna elements (Nₚ=2), with N₁=4 horizontal antenna elements and N₂=4 vertical antenna elements.

FIG. 3 shows an example of CSI-RS REs for 12 antenna ports.

FIG. 4 illustrates an example of CJT over two TRPs.

FIGS. 5 and 6 are flowcharts illustrating operations of a UE according to some embodiments.

FIG. 7 is a flowchart illustrating operations of a network node according to some embodiments.

FIG. 8 shows an example of a communication system in accordance with some embodiments.

FIG. 9 shows a UE in accordance with some embodiments.

FIG. 10 shows a network node in accordance with some embodiments.

FIG. 11 is a block diagram of a host in accordance with various aspects described herein.

FIG. 12 is a block diagram illustrating a virtualization environment in which functions implemented by some embodiments may be virtualized.

FIG. 13 shows a communication diagram of a host communicating via a network node with a UE over a partially wireless connection in accordance with some embodiments.

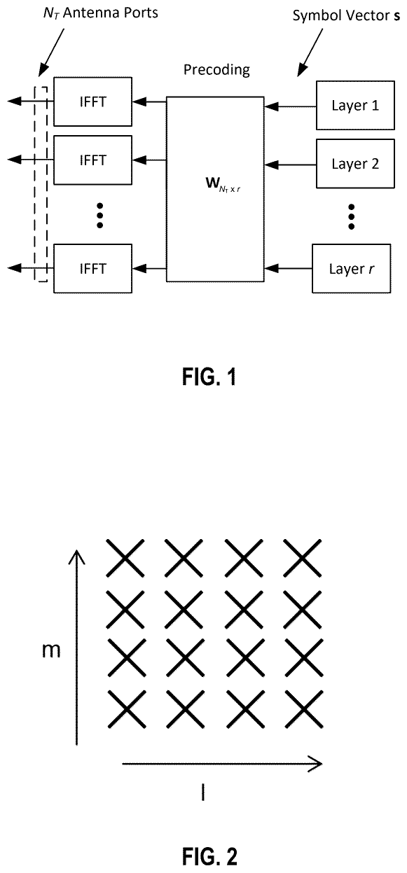

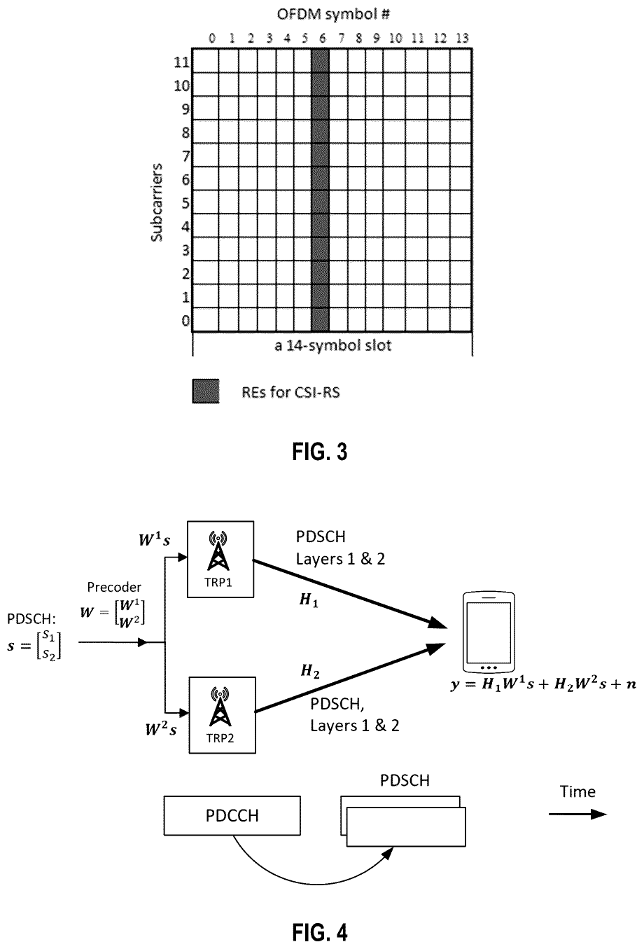

### DETAILED DESCRIPTION

There currently exist certain challenge(s). When the Rel-16 eType II codebook is used for multiple TRP (mTRP) coherent joint transmission, not every TRP is always used/selected by the UE. Consequently, the linear combination coefficient matrix in the eType II codebook will contain many zeros, which means a TRP is not selected at all or not selected for a given transmission layer. If the legacy Rel-16 eType II codebook is reused, a non-zero coefficient (NZC) bitmap needs to be reported as long as there is one NZC for a layer, this results in huge overhead for reporting the NZC bitmap.

Certain embodiments may provide solutions to these or other challenges. Some embodiments provide methods for identifying which TRP is not selected/recommended by the UE for transmitting a transmission layer. Based on this information, methods to save overhead for an eType II CSI report are proposed.

Some embodiments provide a method for reporting Type II CSI by a UE. According to some embodiments, a UE receives a configuration or other indication or signaling from the network for more than one NZP CSI-RS resource for channel measurement. The UE performs channel measurement on the more than one NZP CSI-RS resource for channel measurement and computes Type II CSI based on the measured channel.

The UE includes in CSI Part 1 of the Type II CSI at least one of the following: indicators for selected NZP CSI-RS resources in Part 1, indicators for selected NZP CSI-RS resources with a first value (e.g., with a non-zero value) and indicators for the non-selected NZP CSI-RS resources with a second value (e.g., with a zero value) in Part 1. The indicators may include a bitmap for indicating the non-zero coefficient bitmaps that are reported in CSI Part 2.

Moreover, the UE includes non-zero coefficient bitmaps corresponding to the selected NZP CSI-RS resources in Part 2 of the Type II CSI, and may omit the non-zero coefficient bitmaps corresponding to the non-selected NZP CSI-RS resources in Part 2 of the Type II CSI.

The UE may include the non-zero coefficients reported via a set of amplitude and phase indicators corresponding to the non-zero coefficients indicated by each non-zero coefficient bitmap included in Part 2.

The UE reports the Type II CSI composed of Part 1 and Part 2 to the network. Part 1 CSI may include other quantities, such as rank indicator and/or CQI.

In some embodiments, the indicators for selecting and/or non-selecting NZP CSI-RS resources are NZP CSI-RS resource indicators (CRIs).

In some embodiments, the indicators for selecting and/or non-selecting NZP CSI-RS resources are the number of selected spatial domain (SD) basis vector indicators per NZP CSI-RS resource (i.e., number of selected SD basis vectors is indicated by an indicator per NZP CSI-RS resource).

In some embodiments, the indicators for selecting and/or non-selecting NZP CSI-RS resources are the number of non-zero coefficients indicted per NZP CSI-RS resource (i.e., the number of non-zero coefficients is indicated by an indicator per NZP CSI-RS resource).

In some embodiments, the indicators in Part 1 for selecting and/or non-selecting NZP CSI-RS resources also select transmission layers. For example, one or more of the following can apply:
a first indicator indicating selection/non-selection a first NZP CSI-RS for a first transmission layer;
a second indicator indicating selection/non-selection of the first NZP CSI-RS for a second transmission layer;
a third indicator indicating selection/non-selection a second NZP CSI-RS for the first transmission layer; and/or.
a fourth indicator indicating selection/non-selection of the second NZP CSI-RS for the second transmission layer.

In some further embodiments, the UE may include in Part 2 one non-zero coefficient bitmap for each indictor that indicates selection of one NZP CSI-RS and one of the transmission layers, and may omit from Part 2 the non-zero coefficient bitmaps corresponding to each indicator that indicates non-selection of one NZP CSI-RS and one of the transmission layers. In some further embodiments, the UE may include the non-zero coefficients indicated by each bitmap in Part 2 where each non-zero coefficient is indicated via a set of amplitude and phase indicators.

In some embodiments, each NZP CSI-RS resource represents a TRP.

Certain embodiments may provide one or more technical advantages. For example, some embodiments enable the UE to omit the NZC bitmaps corresponding to one or more NZP CSI-RS resources (or TRPs) and/or transmission layers to save CSI reporting overhead, where applicable. This may help significantly reduce the Type II CSI reporting overhead for the CJT use case.

Some of the embodiments contemplated herein will now be described more fully with reference to the accompanying drawings. Embodiments are provided by way of example to convey the scope of the subject matter to those skilled in the art.

It has been agreed in 3GPP that each TRP or TRP group is associated with a NZP CSI-RS resource, therefore, in this description, TRP, TRP group and NZP CSI-RS resource are used interchangeably.

In the legacy Rel-16 Type II codebook, the total number of non-zero coefficients (NNZC) across all layers, i.e., KNZ, are reported in CSI Part 1, which is used by the gNB to derive the payload size of CSI Part 2. The actual number and location of NZCs for each transmission layer are identified by a layer-specific NZC bitmap. Note that the legacy Rel-16 eType II codebook only supports CSI reporting using a single TRP or a single NZP CSI-RS resource.

For Type II codebook enhancement for mTRP (i.e., with CJT), there can be two options on NZC bitmap designs. One design is to have a single NZC bitmap per layer across all NZP CSI-RS resources (or TRPs). The other design option is to have a separate NZC bitmap per layer for each NZP CSI-RS resource (or each TRP). Because SD basis (i.e., W₁) is separately selected for each NZP CSI-RS resource, it is more reasonable to report one bitmap per layer per NZP CSI-RS resource (i.e., TRP or TRP group). This is because even if multiple NZP CSI-RS resources (i.e., TRPs, TRP groups) are configured, not all the NZP CSI-RS resources are always good and used/recommended by the UE, the coefficients in the reported linear combination matrix W₂ associated to the unused/unselected NZP CSI-RS resources would have a value of zero. This could happen in many scenarios, for example, when a UE has much weaker link to some of the TRPs comparing to the other TRPs, or when different TRPs are good for different transmission layers (e.g., TRP 1 and TRP 2 are used for layer 1, TRP 2 and TRP 3 are used for layer 2).

In addition, there is a maximum NNZCs that can be reported, so the remaining non-reported coefficients need to be set to zeros. Because a weak TRP is usually associated with weak linear combination coefficients (LCCs), this further increases the chance that weak TRPs are not selected by the UE. As a result, the W₂ matrix (or the part of W₂, if W₂ is across all TRPs) associated with the unused/unrecommended TRP contains only zero elements. Note that reporting of NZC bitmap is a primary contributor to the overhead, only second to reporting of the actual quantized NZCs (assuming most NZC are reported), and thus reporting a bitmap where the corresponding elements to that bitmap are all zeros is a waste of uplink resources.

In some embodiments, it is assumed that when eType II codebook is used for mTRP with CJT, separate NZC bitmaps, one for each NZP CSI-RS resource per transmission layer, are used for identifying the reported NZC from the LCC matrix W₂. Then, each reported LCC matrix W₂ and the corresponding NZC bitmap is associated with a TRP and a transmission layer.

In 3GPP TS 38.214 v17.2.0, the Rel-16 eType II NZC bitmap is reported/indicated by an index

$${i}_{1 , 7 , l} = [ {k}_{l , 0}^{( 3 )} , … , {k}_{l , {M}_{v} - 1}^{( 3 )} ] ,$$

where

$${k}_{l , f}^{( 3 )} = [ {k}_{l , 0 , f}^{( 3 )} , {k}_{l , 1 , f}^{( 3 )} , … , {k}_{l , 2 L - 1 , f}^{( 3 )} ]$$

with

$${k}_{l , i , f}^{( 3 )} ∈ \{ 0 , 1 \} ,$$

and
l=, 1, . . . , v is the layer index, with v being the transmission rank.
i=0, . . . , 2 L−1 is the SD basis index
f=0, . . . , Mᵥ−1 is the FD basis index, with Mᵥ being the number of selected FD basis vectors.

The above NZC bitmap for Rel-16 eType II codebook for a single TRP can be extended to support N TRPs/TRP-groups (i.e., N CSI-RS resources), by introducing an index for each TRP/TRP-group (i.e., for each CSI-RS resource). Then, for CSI-RS resource n, the bitmap can be reported/indicated by an index

$${i}_{1 , 7 , l , n} = [ {k}_{l , 0 , n}^{′ ( 3 )} , … , {k}_{l , {M}_{ν , n} - 1 , n}^{′ ( 3 )} ] ,$$

where

$${k}_{l , {f}_{n} , n}^{′ ( 3 )} = [ {k}_{l , 0 , {f}_{n} , n}^{′ ( 3 )} , {k}_{l , 1 , {f}_{n} , n}^{′ ( 3 )} , , {k}_{l , 2 , {L}_{n} - 1 , {f}_{n} , n}^{′ ( 3 )} ]$$

with
with

$${k}_{l , {i}_{n} , {f}_{n} , n}^{′ ( 3 )} ∈ \{ 0 , 1 \} ,$$

and
l=, 1, . . . , v is the layer index, with v being the transmission rank
iₙ=0, . . . , 2 Lₙ−1 is the SD basis index associated with CSI-RS resource n, and Lₙ is the number of selected SD basis vectors for CSI-RS resource n.
fₙ=0, . . . , M_{v,n}−1, is the FD basis index associated with CSI-RS resource n and layer v, and M_{v,n} is the number of selected FD basis vectors for CSI-RS resource n and layer v
n=1, . . . N is an index associated with the n^{th} CSI-RS resource, and N is the total number of CSI-RS resources.

Note that LCCs from matrix W₂ corresponding to a given NZP CSI-RS resource (or TRP) and a given transmission layer may be reported as a set of amplitude and phase coefficient indicators wherein the number of indicators depends on the number of NZCs indicated by the bitmap corresponding to the given NZP CSI-RS resource (or TRP) and the given transmission layer.

Some embodiments provide methods for enabling the UE to omit the NZC bitmaps corresponding to one or more NZP CSI-RS resources (or TRPs) and/or transmission layers to save CSI reporting overhead, where applicable.

Explicit indication can be used for indicating which NZC bitmap is reported, where each NZC bitmap is associated with a CSI-RS resource and/or a transmission layer.

### Omit Reporting of NZC Bitmap According to NZP CSI-RS Resource Indicator (CRI)

In mTRP operation with CJT, each TRP or TRP group is associated with an NZP CSI-RS resource. When a configured TRP (i.e., NZP CSI-RS resource) is not selected by the UE, for example, a configured TRP has weak link to the served UE compared to other configured TRPs, then, this TRP may not be selected by the UE, and the CRI associated with the non-selected TRP is not reported to the network. Alternatively, the CRI associated with the non-selected TRP is indicated with a value of zero in CSI Part 1. In this way, the corresponding NZC bitmap is omitted in CSI Part 2 from the CSI reported to the gNB, since the LCC matrix W₂ associated with this TRP only contains zeros.

In one embodiment, the NZC bitmap associated with a NZP CSI-RS resource (i.e., TRP or TRP group) that is not selected is not reported to the gNB.

In some embodiments, the NZP CSI-RS resource that is not selected is identified from the reported CRI values (e.g., a reported value of 0 for CRI corresponding to a first NZP CSI-RS resource).

### Omit Reporting of NZC Bitmap According to Selected SD Basis Vectors

In some cases, a UE is configured by the gNB a total number of SD basis vectors, Lₜₒₜ, while it is up to the UE to determine the number of selected SD basis vectors for each NZP CSI-RS resource (i.e., TRP or TRP group). Denote the number of selected SD basis vectors for NZP CSI-RS resource n as Lₙ. Then,

$${L}_{tot} = {\sum }_{n = 1}^{N} {L}_{n} ,$$

where N is the total number of configured NZP CSI-RS resources (i.e., TRPs, or TRP groups). Note that if Lₜₒₜ is configured as the maximum number of selected of SD basis vectors across all NZP CSI-RS resources, then

$${L}_{tot} \geq {\sum }_{n = 1}^{N} {L}_{n}$$

(i.e., the number or selected SD basis vectors across all NZP CSI-RS resources by the UE can be smaller than the maximum number of selected SD basis vectors across all NZP CSI-RS resources).

It may happen that SD basis vectors are only selected from a subset of NZP CSI-RS resources, i.e., Lₙ=0 for some n values. This could be because there exist NZP CSI-RS resources (i.e., TRPs or TRP groups) with a weak link to the served UE, etc. The corresponding bitmap is then not reported by the UE.

In some embodiments, if the number of selected SD basis vectors for a NZP CSI-RS resource (i.e., TRP or TRP group) is zero, the associated bitmap for the said NZP CSI-RS resource is not reported.

In some embodiments, the number of selected SD basis vectors per TRP, i.e., Lₙ for n=1, . . . N is reported to the gNB, and the bitmap associated with NZP CSI-RS resource n is not reported if Lₙ=0.

In some examples, the selected SD basis vectors are reported to the gNB in a bitmap, whose size equals to the total number of configured NZP CSI-RS ports divided by two, and then sum over all configured NZP CSI-RS resources. In the bitmap ‘1’ indicates a selected SD basis vector while ‘0’ indicates a non-selected SD basis vector. If the total number of ‘1’s associated with a NZP CSI-RS resource is zero, then, the bitmap associated with the said NZP CSI-RS resource is not reported.

In some embodiments, the number of selected SD basis vectors is indicated in Part 1 of CSI report while the associated bitmap for the NZP CSI-RS(s) from which SD basis vectors are selected are in Part 2 of the CSI report.

### Omit Reporting of NZC Bitmap According to the Reported Number of NZC (NNZC)

Determining whether a NZC bitmap is reported can also be based on the reported NNZC.

One possible solution is to report the total NNZCs per NZP CSI-RS resource, for example denoted as

$${K}_{n}^{NZ} ,$$

where n=1, . . . , N is the NZP CSI-RS resource index. If a TRP is not recommended by the UE, then

$${K}_{n}^{NZ} = 0$$

is reported (e.g., in CSI part 1), and the corresponding bitmap is not reported in CSI Part 2.

Another alternative is to report the total NNZCs per NZP CSI-RS resource and also per layer, for example denoted as

$${K}_{n , l}^{NZ} ,$$

where n=1, . . . , N is the NZP CSI-RS resource index, and l=1, . . . , v is the layer index. If a NZP CSI-RS resource is not recommended by the UE for a layer, then

$${K}_{n , l}^{NZ} = 0$$

is reported (e.g., in CSI Part 1), and the corresponding bitmap is not reported in CSI Part 2.

### Omitting Reporting of NZC Bitmap According to Explicit Indication Using Bitmap (“Bitmap of Bitmaps”)

In some cases, the indication for reported bitmaps is only TRP-specific, i.e., per NZP CSI-RS resource. In one embodiment, a bitmap of size N, where N is the number of selected TRPs by the UE, is used for indicating the NZC bitmap reported by the UE. In an alternative embodiment, a bit map of size N is used, where N is the number of CSI-RS resources configured by the gNB. This way the length N bitmap can be used to select a subset of TRPs (i.e., a subset of CSI-RS resources among the N CSI-RS resources). In some embodiments, the length N bitmap is reported as part of Part 1 of CSI.

For example, the bitmap for indicating the reported NZC bitmap in 3GPP specification may be reported/indicated by a new index, e.g., denoted as

$${i}_{1 , 9 , n} = [ {k}_{1}^{( 4 )} , {k}_{2}^{( 4 )} , … , {k}_{N}^{( 4 )} ] ,$$

where

$${k}_{n}^{( 4 )} ∈ \{ 0 , 1 \}$$

for n=1, . . . , N. When

$${k}_{n}^{( 4 )} = 0 ,$$

the associated NZC bitmap for TRP n (i.e., CSI-RS resource n), i.e., i_{1,7,l,n} for l=1, . . . , v, contains only zeros and thus is not reported. The corresponding LCCs should be treated as zeros and are not reported as part of CSI feedback by the UE.

In an alternative embodiment, the number of selected (or unselected) TRPs or NZP CSI-RS resources are reported in Part 1 of the CSI. The selected NZP CSI-RS resources or TRPs are indicated (e.g., by i_{1,9,n}) in Part 2 of the CSI. This would reduce the payload size of the Part 1 CSI at the cost of a slight payload size increase of Part 2 CSI. For example, for 4 NZP CSI-RS resources/TRPs configured, 2 bits are needed while 4 bits are needed when a bitmap (e.g., i_{1,9,n}) is used in Part 1 CSI. Smaller payload size of Part1 CSI is desirable for reliable decoding.

In another embodiment, the total number of UE selected SD basis vectors or beams across all TRPs/NZP CSI-RS resources is reported in Part1 CSI. The selected NZP CSI-RS resources or TRPs as well as the selected number of SD basis vectors (i.e., Lₙ) associated to each of the selected TRPs are indicated (e.g., by i_{1,9,n}) in Part 2 of the CSI.

In some other cases, the indication for reported bitmaps is both TRP- and layer-specific, i.e., per NZP CSI-RS resource and per layer. In one embodiment, a bitmap of size Nv′, where v′ is the maximum transmission rank configured by the gNB or supported or reported by the UE (i.e., Nv′ is known by the gNB prior to receiving the CSI), is used for indicating the NZC bitmap reported by the UE.

For example, the bitmap for indicating the reported NZC bitmap for CSI-RS resource n and layer l in 3GPP specification may be reported/indicated by a new index, e.g., denoted as

$${i}_{1 , 9 , l , n} = [ {k}_{l , 1}^{( 4 )} , {k}_{l , 2}^{( 4 )} , … , {k}_{l , N}^{( 4 )} ] ,$$

where

$${k}_{l , n}^{( 4 )} ∈ \{ 0 , 1 \}$$

for n=1, . . . , N and l=1, . . . , v′. When

$${k}_{l , n}^{( 4 )} = 0 ,$$

for n=1, . . . , N and l=1, . . . , v′, then the associated NZC bitmap, i.e., i_{1,7,l,n}, for TRP n (i.e., NZP CSI-RS resource n) and layer l, contains only zeros and thus is not reported. The corresponding LCCs should be treated as zeros and are not reported as part of CSI by the UE. Note that

$${k}_{l , n}^{( 4 )} = 0 ,$$

for n=1, . . . , N and l=v+1, . . . , v′ when v′>v.

The above-mentioned bitmaps for indicating the reported NZC bitmaps, either i_{1,9,n} for TRP-specific indication or i_{1,9,l,n} for TRP- and layer-specific indication, are reported in CSI Part 1, and the NZC bitmaps, i.e., {i_{1,7,l,n}, n=1, . . . , N; l=1, . . . , v} except the ones with all zeros as indicated in i_{1,9,n} or i_{1,9,l,n}, are reported in CSI Part 2. Then, i_{1,9,n} or i_{1,9,l,n} can be used by the gNB to determine the payload size of reporting i_{1,7,l,n}.

In an alternative embodiment, the total number of selected layers across all TRPs are reported in Part 1 of the CSI. The selected NZP CSI-RS resources or TRPs and the selected layers for each TRP are indicated (e.g., by i_{1,9,l,n}) in Part 2 of the CSI. This would reduce the payload size of the Part 1 CSI by slightly payload size at the cost of a slight payload size increase of Part 2 CSI. For example, when 4 NZP CSI-RS resources/TRPs are configured and the maximum rank is 4, then 4bits are needed to indicate the total number of layers (e.g., from 1 to 16) across all TRPs while 16 bits would be needed by using a bitmap (e.g., i_{1,9,l,n}) in Part 1 CSI.

### gNB Reconstructing the Precoder

When a NZC bitmap is not reported by the UE, the gNB shall assume that all the corresponding elements in the LCC W₂ matrix are all zeros.

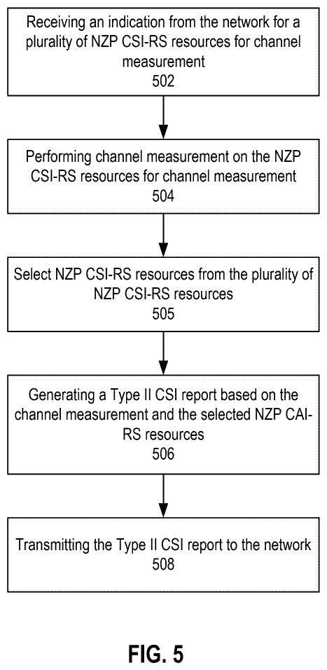

FIG. 5 illustrates a method performed by a UE according to some embodiments. The steps shown in FIG. 5 can be performed in the order and combination shown or in a different order or combination. The method includes receiving (block 502) an indication, configuration or other signaling from a network for a plurality of NZP CSI-RS resources for channel measurement. In response to the indication, the UE performs (block 504) channel measurement on the plurality of NZP CSI-RS resources for channel measurement.

At block 805, the UE selects one or more NZP CSI-RS resources from the plurality of NZP CSI-RS resources;

At block 806, the UE generates a Type II CSI based on the channel measurement and the selected one or more NZP CSI-RS resources. The UE reports (block 508) the Type II CSI composed of Part 1 and Part 2 to the network.

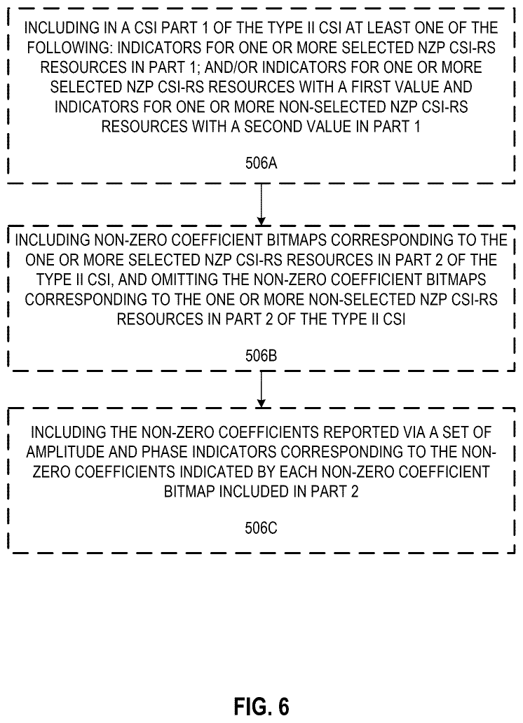

FIG. 6 illustrates some operations that may be performed as part of generating the Type II CSI report in block 806 of FIG. 5. For example, for generating the Type II CSI report, the UE may include (block 506A) in a CSI Part 1 of the Type II CSI at least one of the following: (a) indicators for one or more selected NZP CSI-RS resources in Part 1 and/or (b) indicators for one or more selected NZP CSI-RS resources with a first value (e.g., with a non-zero value) and indicators for one or more non-selected NZP CSI-RS resources with a second value (e.g., with a zero value) in Part 1. In some embodiments, the UE may include (block 506B) non-zero coefficient bitmaps corresponding to the one or more selected NZP CSI-RS resources in Part 2 of the Type II CSI, and omit the non-zero coefficient bitmaps corresponding to the one or more non-selected NZP CSI-RS resources in Part 2 of the Type II CSI. In some embodiments, the UE may include (block 506C) the non-zero coefficients reported via a set of amplitude and phase indicators corresponding to the non-zero coefficients indicated by each non-zero coefficient bitmap included in Part 2 of the Type II CSI.

The steps shown in FIG. 6 can be performed in the order and combination shown or in a different order or combination.

The indicators for one or more selected NZP CSI-RS resources are included in part 1 of the Type II CSI report, and the non-zero coefficient bitmaps are included in part 2 of the Type II CSI report.

Part 2 of the Type II CSI report may omit non-zero coefficient bitmaps corresponding to the non-selected NZP CSI-RS resources in the plurality of NZP CSI-RS resources.

The non-zero coefficients indicated by the non-zero coefficient bitmaps corresponding to the one or more selected NZP CSI-RS resources may be reported in the Type II CSI report via a set of amplitude and phase indicators corresponding to the non-zero coefficients indicated by each of the non-zero coefficient bitmaps included in the Type II CSI report.

Part 1 of the Type II CSI report further includes a rank indicator (RI) and/or a channel quality indicator (CQI). The indicators for the one or more selected NZP CSI-RS resources may include NZP CSI-RS resource indicators (CRIs).

The indicators for the one or more selected NZP CSI-RS resources may include a number of selected spatial domain (SD) basis vectors per NZP CSI-RS resource.

The indicators for the one or more selected NZP CSI-RS resources may include a number of non-zero coefficients indicated per the one or more selected NZP CSI-RS resources.

The indicators for the one or more selected NZP CSI-RS resources may also indicate a number of transmission layers associated with the selected NZP CSI-RS resources.

In some embodiments, the indicators for the one or more selected NZP CSI-RS resources may include a first indicator indicating selection of a first NZP CSI-RS resource for a first transmission layer, and/or a second indicator indicating selection of the first NZP CSI-RS resource for a second transmission layer, and/or a third indicator indicating selection of a second NZP CSI-RS resource for the first transmission layer, and/or a fourth indicator indicating selection of the second NZP CSI-RS resource for the second transmission layer.

The Type II CSI report may include one non-zero coefficient bitmap for each indicator that indicates selection of one NZP CSI-RS resource and one of the transmission layers.

Each non-zero coefficient may be indicated via a set of amplitude and phase indicators.

Each NZP CSI-RS resource may represent a transmit/receive point, TRP.

The indicators for the one or more selected NZP CSI-RS resources may be provided in a bitmap for indicating the non-zero coefficient bitmaps that are included in part 2 of the Type II CSI report.

The bitmap for indicating the non-zero coefficient bitmaps may be included in part 1 of the Type II CSI report, and the non-zero coefficient bitmaps may be included in part 2 of the Type II CSI report.

Each bit in the bitmap for indicating the non-zero coefficient bitmaps may be associated with a configured NZP CSI-RS resource.

Each bit in the bitmap for indicating the non-zero coefficient bitmaps associated with a selected NZP CSI-RS resource may indicate one non-zero coefficient bitmap for each transmission layer.

In some embodiments, each bit in the bitmap for indicating the non-zero coefficient bitmaps associated with a selected NZP CSI-RS resource n may be associated with v different non-zero coefficient bitmaps i_{(1,7,l,n}) (l=1, 2, . . . , v), wherein v is the transmission rank, l is the transmission layer index, and i_{(1,7,l,n)} is the non-zero coefficient bitmap associated with the selected NZP CSI-RS resource n and transmission layer l.

The Type II CSI report may include one non-zero coefficient bitmap for each indicator that indicates selection of one NZP CSI-RS resource and one of the transmission layer.

The non-zero coefficients indicated by each non-zero coefficient bitmap may be indicated via a set of amplitude and phase indicators.

The Type II CSI report may include the non-zero coefficients.

The non-zero coefficients may be reported in the Type II CSI report via a set of amplitude and phase indicators corresponding to the non-zero coefficients indicated by each non-zero coefficient bitmap included in the Type II CSI report.

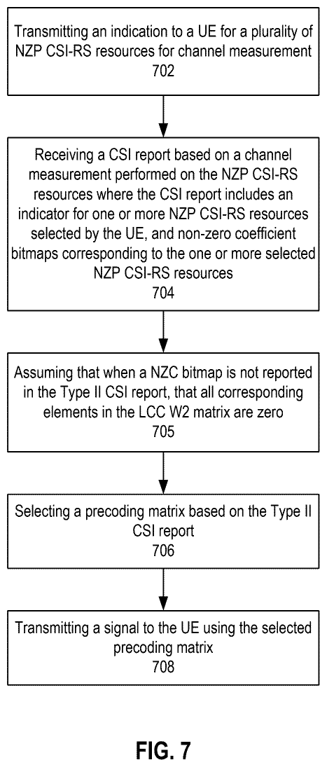

FIG. 7 illustrates a method performed by a network node according to some embodiments of the disclosure. The steps shown in FIG. 7 can be performed in the order and combination shown or in a different order. The network node transmits (block 702) an indication to a UE for a plurality of NZP CSI-RS resources for channel measurement. The network node receives (block 704) a CSI report based on a channel measurement on the plurality of NZP CSI-RS resources. The CSI report includes an indicator for one or more NZP CSI-RS resources selected by the UE, and non-zero coefficient bitmaps corresponding to the one or more selected NZP CSI-RS resources.

The CSI report may be a Type II CSI report that includes non-zero coefficient bitmaps based on the channel measurement and a bitmap for indicating the non-zero coefficient bitmaps that are included in the Type II CSI report.

When a NZC bitmap is not reported by the UE, the network node assumes (block 705) that all the corresponding elements in the LCC W₂ matrix are all zeros.

The network node selects a precoding matrix based on the Type II CSI report (block 706) and transmits a signal to the UE using the selected precoding matrix (block 708).

The Type II CSI report may include non-zero coefficient bitmaps based on the channel measurement and a bitmap for indicating the non-zero coefficient bitmaps that are included in the Type II CSI report.

The bitmap for indicating the non-zero coefficient bitmaps may be included in Part 1 of the Type II CSI report, and the non-zero coefficient bitmaps may be included in Part 2 of the Type II CSI report.

Part 1 of the Type II CSI report may include a RI and/or a CQI.

Each bit in the bitmap for indicating the non-zero coefficient bitmaps may be associated with a configured NZP CSI-RS resource.

Each bit in the bitmap for indicating the non-zero coefficient bitmaps associated with a selected NZP CSI-RS resource may indicate one non-zero coefficient bitmap for each transmission layer.

Each bit in the bitmap for indicating the non-zero coefficient bitmaps associated with a selected NZP CSI-RS resource n may be associated with v different non-zero coefficient bitmaps i_{(1,7,l,n)} (l=1, 2, . . . , v), wherein v is the transmission rank, l is the transmission layer index, and i_{(1,7,l,n)} is the non-zero coefficient bitmap associated with the selected NZP CSI-RS resource n and transmission layer/.

The Type II CSI report may include one non-zero coefficient bitmap for each indictor that indicates selection of one NZP CSI-RS resource and one of the transmission layers, and the Type II CSI report may omit non-zero coefficient bitmaps corresponding to each indicator that indicates non-selection of one NZP CSI-RS resource and one of the transmission layers.

The non-zero coefficients indicated by each non-zero coefficient bitmap may be indicated via a set of amplitude and phase indicators

The Type II CSI report may include the non-zero coefficients.

The non-zero coefficients may be reported in the Type II CSI report via a set of amplitude and phase indicators corresponding to the non-zero coefficients indicated by each non-zero coefficient bitmap included in the Type II CSI report.

Each NZP CSI-RS resource may represent a TRP.

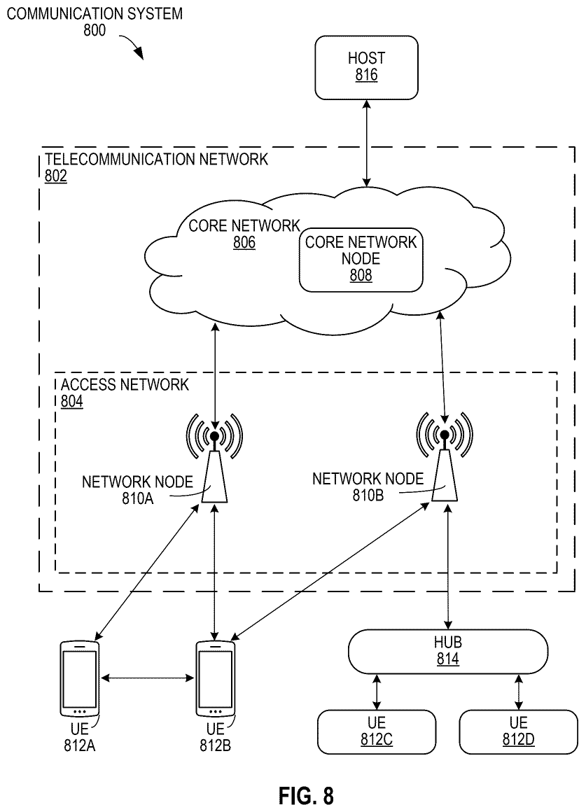

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3GPP access node or non-3GPP access point. The network nodes 810 facilitate direct or indirect connection of UE, such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub-that is, a hub whose primary function is to route communications to/from the UEs from/to the network node 810b. In other embodiments, the hub 814 may be a non-dedicated hub-that is, a device which is capable of operating to route communications between the UEs and network node 810b, but which is additionally capable of operating as a communication start and/or end point for certain data channels.

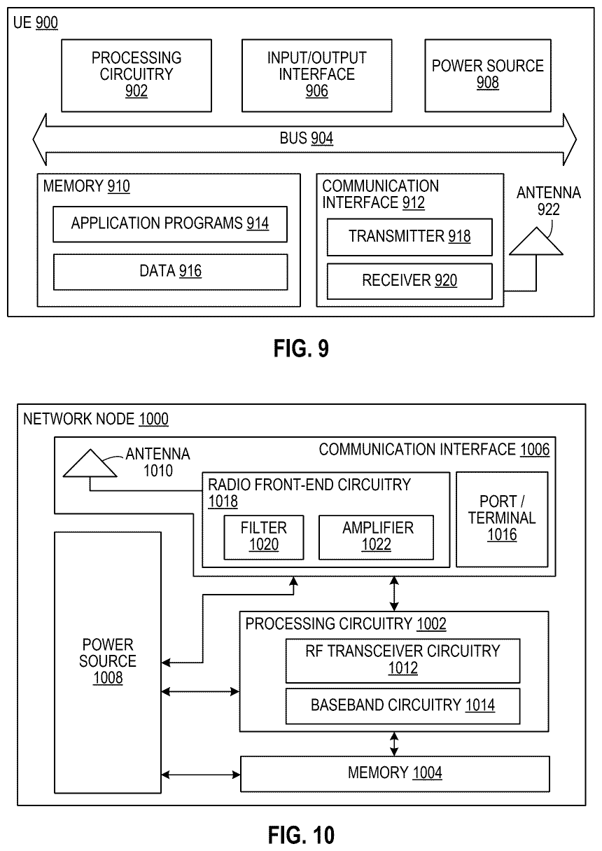

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices.

In particular embodiments, the UE 900 is configured to receive an indication from a network node for a plurality of non-zero power (NZP) channel state information reference signal (CSI-RS) resources for channel measurement, and perform channel measurement on the plurality of NZP CSI-RS resources. The UE 900 selects one or more NZP CSI-RS resources from the plurality of NZP CSI-RS resources, and generates a CSI report based on the channel measurement and the selected one or more NZP CSI-RS resources. The CSI report includes indicators for the one or more selected NZP CSI-RS resources and non-zero coefficient bitmaps corresponding to the one or more selected NZP CSI-RS resources. The UE 900 transmits the CSI report to the network.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable ROM (PROM), erasable PROM (EPROM), electrically erasable PROM (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

A UE, when in the form of an IoT device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, and any kind of medical device, like a heart rate monitor or a remote controlled surgical robot, etc. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, eNBs and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NBs. In such a scenario, each unique NB and RNC pair, may in some instances be considered a single separate network node. In some embodiments, the network node 1000 may be configured to support multiple RATs. In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In particular embodiments, the network node 1000 transmits an indication to a user equipment for a plurality of NZP CSI-RS resources for channel measurement, and receives a CSI report based on a channel measurement on the plurality of NZP CSI-RS resources. In response to determining that the CSI report does not include a non-zero coefficient bitmap for a first NZP CSI-RS resource of the plurality of NZP CSI-RS resource, the network node may assume that corresponding elements in a linear combination coefficient (LCC) matrix are zero. The network node selects a precoding matrix for transmissions to the UE based on the CSI report, and transmits a signal to the UE using the selected precoding matrix.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, RAM, ROM, mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

FIG. 11 is a block diagram of a host 1100, which may be an embodiment of the host 1016 of FIG. 10, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

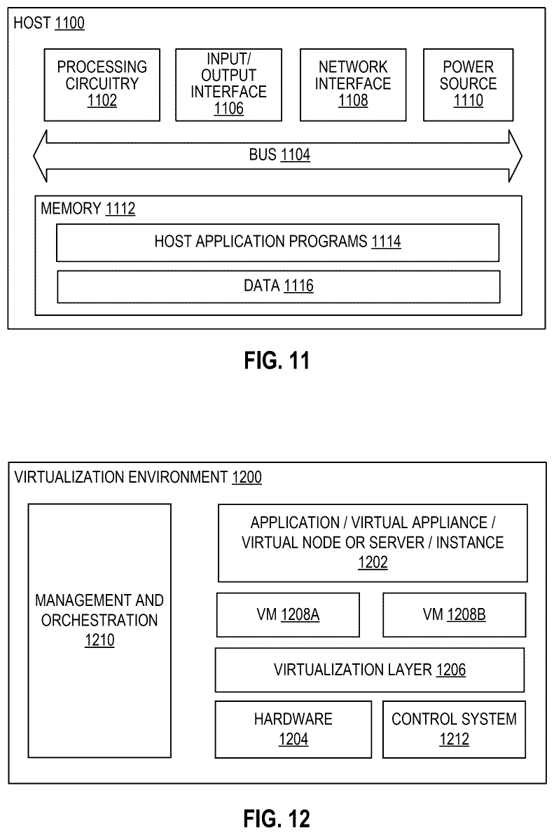

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 11 and 12, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

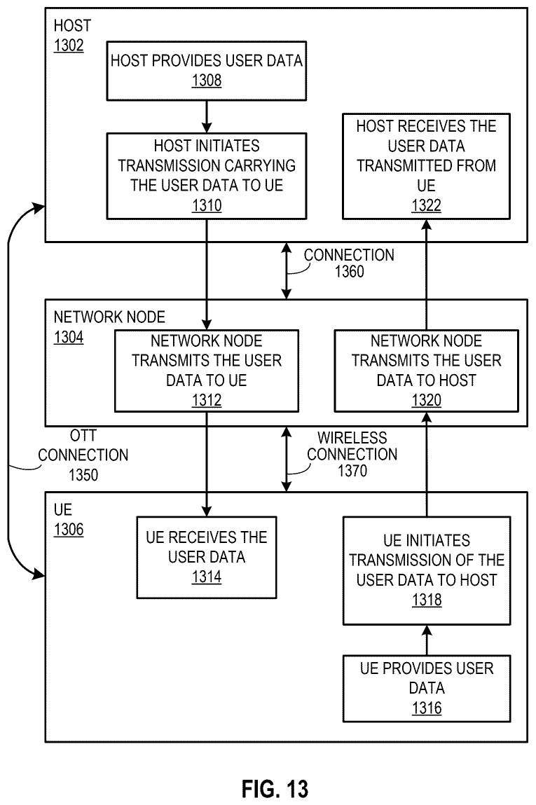

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 13.

Like host 1300, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 1006 of FIG. 10) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may reduce the CSI reporting overhead for coherent joint downlink transmission and thereby provide benefits such as increased network capacity and reduced latency.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a user equipment, UE, comprising:
receiving an indication from a network node for a plurality of non-zero power, NZP, channel state information reference signal, CSI-RS, resources for channel measurement;
performing channel measurement on the plurality of NZP CSI-RS resources;
selecting more than one NZP CSI-RS resources from the plurality of NZP CSI-RS resources;
generating a channel state information, CSI, report based on the channel measurement and the selected more than one NZP CSI-RS resources, wherein the CSI report includes an indicator for the more than one selected NZP CSI-RS resources, and one non-zero coefficient bitmap corresponding to each of the more than one selected NZP CSI-RS resources; and
transmitting the CSI report to the network.

2. The method of claim 1, wherein the indicators for the more than one selected NZP CSI-RS resources are included in Part 1 of the CSI report, and the one non-zero coefficient bitmap corresponding to each of the more than one selected NZP CSI-RS resources are included in Part 2 of the CSI report.

3. The method of claim 1, wherein the indicator for the more than one selected NZP CSI-RS resources is a bitmap comprising a plurality of bits, wherein each bit in the bitmap is associated to one of the plurality of NZP CSI-RS resources, wherein a NZP CSI-RS resource is selected if the corresponding bit in the bitmap is set to one value and wherein a NZP CSI-RS resource is non-selected if the corresponding bit in the bitmap is set to another value.

4. The method of claim 1, wherein non-zero coefficients indicated by the one non-zero coefficient bitmap corresponding to each of the more than one selected NZP CSI-RS resources are reported in the CSI report via a set of amplitude and phase indicators corresponding to the non-zero coefficients indicated by each of the non-zero coefficient bitmaps included in the CSI report.

5. The method of claim 1 wherein Part 1 of the CSI report further comprises a rank indicator and/or channel quality indicator, CQI.

6. The method of claim 1 wherein the indicator for the one or more selected NZP CSI-RS resources comprise NZP CSI-RS resource indicators (CRIs) each associated to one of the plurality of NZP CSI-RS resources, wherein a NZP CSI-RS resource is selected if the corresponding CRI is reported, or
a number of selected spatial domain (SD) basis vectors for each of the plurality of NZP CSI-RS resources, wherein a NZP CSI-RS resource is selected if the corresponding number of selected spatial domain (SD) basis vectors is non-zero, or
a number of non-zero coefficients indicated for each of the plurality of NZP CSI-RS resources, wherein a NZP CSI-RS resource is selected if the corresponding number of non-zero coefficients is non-zero.

7.-8. (canceled)

9. The method of claim 1, wherein the indicator for the more than one selected NZP CSI-RS resources also indicates a number of transmission layers associated with the more than one selected NZP CSI-RS resources.

10. The method of claim 9, wherein the indicator for the more than one selected NZP CSI-RS resources comprises a bitmap wherein each bit in the bitmap is associated to one of the plurality of NZP CSI-RS resources and one of a maximum number of transmission layers, wherein a non-zero coefficient bitmap for a NZP CSI-RS resource and a transmission layer is included in the CSI report if the corresponding bit is set to one value.

11. The method of claim 10, wherein each bit of a non-zero coefficient bitmap is associated to a coefficient and a coefficient is reported in the CSI report if the corresponding bit in the bitmap is set to one value, wherein each reported coefficient or non-zero coefficient comprises an amplitude and a phase indicator.

12. (canceled)

13. The method of claim 1, wherein the indicators for the more than one selected NZP CSI-RS resources comprises a bitmap for indicating the non-zero coefficient bitmaps that are included in Part 2 of the CSI report and wherein the bitmap for indicating the one non-zero coefficient bitmap corresponding to each of the more than one selected NZP CSI-RS resources is included in Part 1 of the CSI report.

14. (canceled)

15. The method of claim 13, wherein each bit in the bitmap for indicating the non-zero coefficient bitmaps is associated with a configured NZP CSI-RS resource and a transmission layer.

16. The method of claim 13, wherein each bit in the bitmap for indicating the non-zero coefficient bitmaps is associated to one non-zero coefficient bitmap for one of a maximum number of transmission layers and one of the plurality of NZP CSI-RS resources, wherein a non-zero coefficient bitmap is included in the CSI report if the corresponding bit in the bitmap is set to one value.

17. The method of claim 13, wherein the CSI report includes one non-zero coefficient bitmap for each indicator that indicates selection of one NZP CSI-RS resource and one of the transmission layer.

18. The method of claim 13, wherein the non-zero coefficients are reported in the CSI report via a set of amplitude and phase indicators corresponding to the non-zero coefficients indicated by each non-zero coefficient bitmap included in the CSI report.

19.-21. (canceled)

22. A method performed by a network node, comprising:
transmitting an indication to a user equipment (UE) for a plurality of non-zero power, NZP, channel state information reference signal, CSI-RS, resources for channel measurement; and
receiving a CSI report based on a channel measurement on the plurality of NZP CSI-RS resources, wherein the CSI report includes an indicator for more than one NZP CSI-RS resources selected by the UE, and one non-zero coefficient bitmap corresponding to each of the more than one selected NZP CSI-RS resources.

23. The method of claim 22, wherein the CSI report includes a bitmap for indicating the one non-zero coefficient bitmap corresponding to each of the more than one selected NZP CSI-RS resources that are included in the CSI report.

24. The method of claim 23, wherein the bitmap for indicating the non-zero coefficient bitmaps is included in Part 1 of the CSI report, and the non-zero coefficient bitmaps are included in Part 2 of the CSI report.

25. The method of claim 23, wherein the bitmap for indicating the non-zero coefficient bitmaps comprises a plurality of bits, wherein each bit in the bitmap is associated to one of the plurality of NZP CSI-RS resources, wherein a NZP CSI-RS resource is selected if the corresponding bit in the bitmap is set to one value and wherein a NZP CSI-RS resource is non-selected if the corresponding bit in the bitmap is set to another value.

26. (canceled)

27. The method of claim 24, wherein each bit in the bitmap for indicating the non-zero coefficient bitmaps is associated with a configured NZP CSI-RS resource and a transmission layer.

28. The method of claim 24, wherein each bit in the bitmap for indicating the non-zero coefficient bitmaps associated with a selected NZP CSI-RS resource indicates one non-zero coefficient bitmap for each transmission layer.

29.-35. (canceled)
